(19) United States
(12) Patent Application Publication
(10) Pub. No.: US 2026/0336875 A1
(43) Pub. Date: Oct. 29, 2026

(54) THERMOFORMABLE FILM AND MANUFACTURING METHOD THEREOF

(71) Applicant: CJ CHEILJEDANG CORPORATION, Seoul (KR)

(72) Inventors: Sang Bong LEE, Seoul (KR); Byungkook LEE, Seoul (KR)

(73) Assignee: CJ CHEILJEDANG CORPORATION, Seoul (KR)

(21) Appl. No.: 19/484,661

(22) PCT Filed: May 16, 2024
(86) PCT No.: PCT/KR2024/006625

§ 371 Date: Nov. 14, 2025

(30) Foreign Application Priority Data
May 16, 2023 (KR) 10-2023-0063185

(51) Int. Cl. B65D 33/00; B32B 1/00; B32B 27/08; B32B 27/32; B32B 27/34

(52) U.S. Cl. CPC B65D 33/00; B32B 1/00; B32B 27/08; B32B 27/32; B32B 27/34; B32B 2250/02; B32B 2250/24; B32B 2255/10; B32B 2255/20; B32B 2307/412; B32B 2307/7244; B32B 2307/7246; B32B 2307/7376; B32B 2439/70

(57) ABSTRACT

The present disclosure provides a thermoformable film including a first unstretched film layer; a stretched film layer; and a second unstretched film layer, and a method of preparing the same.

### TECHNICAL FIELD

The present disclosure relates to a thermoformable film that has excellent gas barrier properties and is thus capable of enhancing the long-term storage capability of contents (e.g., food); and to a process for preparing the same.

### BACKGROUND ART

Thermoformable films are used in the manufacture of retort foods, in which meat products are contained as sealed. The thermoformable films are required to have thermal resistance to withstand the heat sterilization process and gas barrier properties to block oxygen and/or moisture to enable long-term storage of the contents.

In the past, retort foods were manufactured by applying a coextruded film with excellent thermoformability as the thermoformable film. Specifically, a coextruded film is placed in a mold within a chamber. While it is heated, a vacuum is applied to thermoform the coextruded film to fit the shape of the mold. Then, the contents are placed therein and sealed. Next, the sealed contents are subjected to a heat sterilization process to manufacture a retort food.

However, since the coextruded film has a structure in which films of the same thickness are combined (e.g., a structure in which two polypropylene films are combined), the thickness becomes very thin during the process of stretching it to fit the shape of the mold (thermoforming), resulting in poor gas barrier properties. If heat sterilization of the contents is carried out in a state where the gas barrier properties are low, the contents may be adversely affected. Specifically, if the contents are sensitive to thermal treatment conditions or gas permeability, the problem of color change of the contents may occur.

Accordingly, there is a need to develop a thermoformable film that has excellent gas barrier properties and a required level of thermoformability even after it has been subjected to thermoforming and heat sterilization processes.

### PRIOR ART DOCUMENT

### Patent Document

(Patent Document 1) Korean Laid-open Patent Publication No. 2010-0085157

### DISCLOSURE OF INVENTION

### Technical Problem

The present disclosure aims to provide a thermoformable film that has thermoformability and thermal resistance required in a thermoforming process and a heat sterilization process and that can have excellent gas barrier properties even after these processes.

In addition, the present disclosure aims to provide a process for preparing a thermoformable film that can efficiently prepare the thermoformable film.

### Solution to Problem

According to an aspect of the present disclosure in order to solve the above problem, there is provided a thermoformable film that comprises a first unstretched film layer; a stretched film layer comprising a transparent deposition layer formed on one or both sides thereof, and a second unstretched film layer.

In an embodiment, the thermoformable film may have an oxygen transmission rate (OTR) of 20 cc/m²·day or less when measured after it is thermoformed at 120 to 155 °C.

In another embodiment, the thermoformable film may have an oxygen transmission rate (OTR) of 15 cc/m²·day or less when measured after the thermoformed film is heated at 110 to 130 °C for 20 to 30 minutes.

In another embodiment, the first unstretched film layer may have a tensile strength in the longitudinal direction (MD) and the transverse direction (TD) of 110 to 160 MPa, respectively, and an elongation in the longitudinal direction (MD) and the transverse direction (TD) of 400 to 440%, respectively.

In another embodiment, the stretched film layer may have a tensile strength in the longitudinal direction (MD) and the transverse direction (TD) of 240 to 320 MPa, respectively, and an elongation in the longitudinal direction (MD) and the transverse direction (TD) of 80 to 120%, respectively.

In another embodiment, the first unstretched film layer may have an oxygen transmission rate (OTR) of 30 cc/m²·day or less and a water vapor transmission rate (WVTR) of 250 g/m²·day or less.

In another embodiment, the stretched film layer may have an oxygen transmission rate (OTR) of 2 cc/m²·day or less and a water vapor transmission rate (WVTR) of 3 g/m²·day or less.

In another embodiment, the first unstretched film layer and the stretched film layer may each comprise a polyamide, and the second unstretched film layer may comprise a polypropylene.

In another embodiment, the sum of the thickness of the first unstretched film layer and the thickness of the stretched film layer may be smaller than the thickness of the second unstretched film layer.

In another embodiment, the thickness of the first unstretched film layer may be 40 to 60 μm, the thickness of the stretched film layer may be 5 to 25 μm, and the thickness of the second unstretched film layer may be 80 to 120 μm.

In another embodiment, the first unstretched film layer, the stretched film layer, and the second unstretched film layer may be sequentially laminated.

In another embodiment, the transparent deposition layer may comprise at least one selected from the group consisting of aluminum oxide, aluminum oxynitride, titanium oxide, silicon oxide, zinc oxide, tin oxide, silicon nitride, aluminum nitride, silicon oxynitride, nickel oxide, and magnesium oxide.

According to another aspect of the present disclosure, there is provided a process for preparing a thermoformable film that comprises preparing a first unstretched film, a stretched film, and a second unstretched film, respectively; and sequentially laminating and combining the first unstretched film, the stretched film, and the second unstretched film.

According to another aspect of the present disclosure, there is provided a retort pouch that comprises the thermoformable film.

### Advantageous Effects of Invention

As the thermoformable film according to the present disclosure comprises a stretched film layer having gas barrier properties and thermoformability; and first and second unstretched film layers capable of increasing thermoformability, it can have a required level of thermoformability and excellent thermal resistance, sealing properties, gas barrier properties, and the like even after it has been subjected to both the thermoforming process and the heat sterilization process.

Accordingly, when various items such as food, medicine, cosmetics, and industrial products are packaged using the thermoformable film according to the present disclosure, the long-term storage capability of the contents can be enhanced. In particular, since the thermoformable film according to the present disclosure has excellent gas barrier properties even when heat sterilization is performed under harsh conditions as compared with boiling water sterilization, it can be advantageously used in the manufacture of retort pouches used to ensure a long shelf life of processed meat products.

### BRIEF DESCRIPTION OF DRAWINGS

FIG. 1 is a cross-sectional view of a thermoformable film according to an embodiment of the present disclosure.

FIG. 2 is a flow chart showing the process of preparing a thermoformable film according to an embodiment of the present disclosure.

### BEST MODE FOR CARRYING OUT THE INVENTION

Hereinafter, the present disclosure will be described with reference to embodiments. Here, the present disclosure is not limited to the disclosures given below, but it may be modified into various forms as long as the gist of the invention is not changed.

In the present specification, in the case where an element is mentioned to be formed, connected, or combined on or under another element, it means all of the cases where one element is directly, or indirectly through another element, formed, connected, or combined with another element. In addition, it should be understood that the criterion for the terms on and under of each component may vary depending on the direction in which the object is observed.

In the present specification, the term “comprising” is intended to specify a particular characteristic, region, step, process, element, and/or component. It does not exclude the presence or addition of any other characteristic, region, step, process, element and/or component, unless specifically stated to the contrary.

All numbers and expressions related to the quantities of components, reaction conditions, and the like used herein are to be understood as being modified by the term “about” unless otherwise indicated.

Throughout the present specification, the terms first, second, and the like are used to describe various components. But the components should not be limited by the terms. Specifically, the terms are used for the purpose of distinguishing one element from another.

### Thermoformable Film

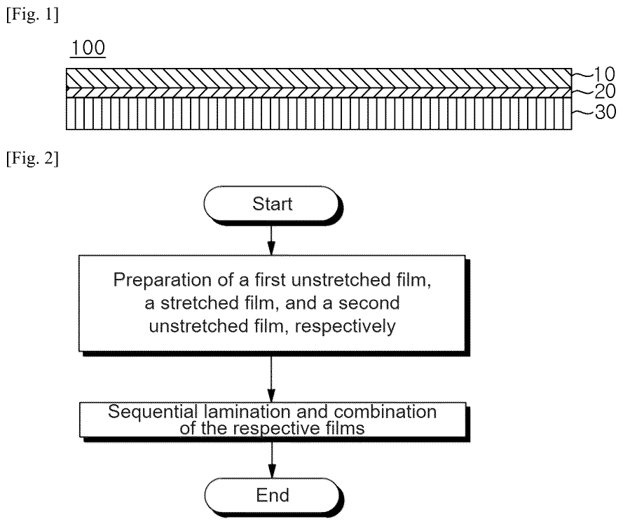

The present disclosure provides a thermoformable film that ensures thermoformability (stretchability) while it has excellent gas barrier properties as compared with conventional coextruded films. Specifically, the thermoformable film according to the present disclosure comprises a first unstretched film layer; a stretched film layer; and a second unstretched film layer, which will be described in detail with reference to FIG. 1, as follows.

### First Unstretched Film Layer

The first unstretched film layer (10) contained in the thermoformable film (100) according to the present disclosure serves to secure the thermal resistance, pinhole resistance, gas barrier properties, and the like of the thermoformable film (100). The first unstretched film layer (10) may be made of a film comprising a polymer resin (first polymer resin), in which case the film may be a film that has not been stretched. The polymer resin (first polymer resin) is not particularly limited, but it may specifically comprise a polyamide. As the first unstretched film layer (10) comprises the polyamide, the pinhole resistance, gas barrier properties, and mechanical strength of the thermoformable film (100) can be enhanced. The polyamide may be specifically at least one selected from the group consisting of nylon 4, nylon 6, nylon 7, nylon 8, nylon 11, nylon 12, nylon 66, nylon 69, nylon 610, nylon 611, nylon 612, nylon 6T, nylon 6/66, nylon 6/12, nylon 6/6T, nylon 6T (terephthalic acid)/6I (isophthalic acid), and nylon MXD6.

According to the present disclosure, the first unstretched film layer (10) may have mechanical (physical) properties (e.g., tensile strength, elongation, etc.) controlled to specific ranges. As a result, it is possible to enhance the thermoformability (stretchability) of the thermoformable film (100) while securing the gas barrier properties thereof.

Specifically, the first unstretched film layer (10) may have a tensile strength of 110 to 160 MPa in the longitudinal direction (MD) and the transverse direction (TD), respectively. For example, the tensile strength in the longitudinal direction (MD) of the first unstretched film layer (10) may be 115 to 160 MPa, 120 to 155 MPa, 125 to 155 MPa, 130 to 150 MPa, 135 to 150 MPa, or 135 to 145 MPa. In addition, the tensile strength in the transverse direction (TD) of the first unstretched film layer (10) may be 110 to 155 MPa, 115 to 150 MPa, 115 to 145 MPa, 120 to 140 MPa, 125 to 135 MPa, or 125 to 130 MPa. Here, the tensile strength (A) in the longitudinal direction (MD) of the first unstretched film layer (10) may be greater than the tensile strength (B) in the transverse direction (TD) thereof (A>B). The tensile strength of the first unstretched film layer (10) may be measured according to the JIS K 7127 standard (at 23 °C).

The first unstretched film layer (10) may have an elongation of 400 to 440% in the longitudinal direction (MD) and the transverse direction (TD), respectively. For example, the elongation in the longitudinal direction (MD) of the first unstretched film layer (10) may be 400 to 435%, 403 to 430%, 405 to 425%, 407 to 420%, or 409 to 415%. In addition, the elongation in the transverse direction (TD) of the first unstretched film layer (10) may be 405 to 440%, 410 to 438%, 415 to 435%, 420 to 435%, or 425 to 433%. Here, the elongation (C) in the longitudinal direction (MD) of the first unstretched film layer (10) may be smaller than the elongation (D) in the transverse direction (TD) thereof (C<D). The elongation of the first unstretched film layer (10) may be measured according to the JIS K 7127 standard (at 23 °C).

Meanwhile, the first unstretched film layer (10) may have a tear strength of 130 to 220 N/cm in the longitudinal direction (MD) and the transverse direction (TD), respectively. For example, the tear strength in the longitudinal direction (MD) of the first unstretched film layer (10) may be 130 to 210 N/cm, 135 to 200 N/cm, 135 to 190 N/cm, 140 to 180 N/cm, 140 to 170 N/cm, or 145 to 155 N/cm. In addition, the tear strength in the transverse direction (TD) of the first unstretched film layer (10) may be 145 to 220 N/cm, 155 to 215 N/cm, 170 to 215 N/cm, 185 to 210 N/cm, or 195 to 205 N/cm. Here, the tear strength (E) in the longitudinal direction (MD) of the first unstretched film layer (10) may be smaller than the tear strength (F) in the transverse direction (TD) thereof (E<F). The tear strength of the first unstretched film layer (10) may be measured according to the JIS K 7128 standard (at 23 °C).

In addition, the first unstretched film layer (10) may have a haze of 4% or less, 3.9% or less, 3.8% or less, 3.7% or less, 3.6% or less, or 3.5% or less. The haze of the first unstretched film layer (10) may be measured according to the JIS K 7105 standard (at 23 °C).

According to the present disclosure, the first unstretched film layer (10) may have an oxygen transmission rate (OTR) of 30 cc/m²·day or less (=30 cc/m²·day atm or less) and a water vapor transmission rate (WVTR) of 250 g/m²·day or less. Specifically, the oxygen transmission rate (OTR) of the first unstretched film layer (10) may be 25 cc/m²·day or less, 20 cc/m²·day or less, 15 cc/m²·day or less, 10 cc/m²·day or less, or 5 cc/m²·day or less, and 0 cc/m²·day or more, 0.0001 cc/m²·day or more, 0.0002 cc/m²·day or more, 0.0003 cc/m²·day or more, or 0.0004 cc/m²·day or more. In addition, the water vapor transmission rate (WVTR) of the first unstretched film layer (10) may be 230 g/m²·day or less, 200 g/m²·day or less, 180 g/m²·day or less, 165 g/m²·day or less, or 150 g/m²·day or less, and 0.00001 g/m²·day or more, 0.00003 g/m²·day or more, 0.00005 g/m²·day or more, 0.0001 g/m²·day or more, or 0.0005 g/m²·day or more. As the oxygen transmission rate (OTR) and water vapor transmission rate (WVTR) of the first unstretched film layer (10) are each within the above range, the gas barrier properties of the thermoformable film (100) can be increased while the thermal resistance and pinhole resistance of the thermoformable film (100) are secured. As a result, it is possible to significantly enhance the long-term storage capability of retort pouches manufactured using the thermoformable film (100). The oxygen transmission rate (OTR) of the first unstretched film layer (10) may be measured according to the JIS K 7126 standard (at 23 °C and 0% RH). The water vapor transmission rate (WVTR) of the first unstretched film layer (10) may be measured according to the JIS K 7129 standard (at 40 °C and 90% RH).

According to the present disclosure, the first unstretched film layer (10) may have a thickness of 40 to 60 μm. Specifically, the thickness of the first unstretched film layer (10) may be 43 to 58 μm, 45 to 55 μm, 48 to 53 μm, or 49 to 51 μm. As the thickness of the first unstretched film layer (10) is within the above range, the gas barrier properties and thermoformability of the thermoformable film (100) can be enhanced.

### Stretched Film Layer

The stretched film layer (20) contained in the thermoformable film (100) according to the present disclosure serves to enhance the thermal resistance, durability, gas barrier properties, thermoformability, and the like of the thermoformable film (100). The stretched film layer (20) may be made of a film obtained by uniaxially or biaxially stretching an unstretched film comprising a polymer resin (second polymer resin). The polymer resin (second polymer resin) is not particularly limited, but it may specifically comprise a polyamide. As the stretched film layer (20) comprises the polyamide, the gas barrier properties, mechanical strength, and thermoformability of the thermoformable film (100) can be enhanced. The polyamide may be specifically at least one selected from the group consisting of nylon 4, nylon 6, nylon 7, nylon 8, nylon 11, nylon 12, nylon 66, nylon 69, nylon 610, nylon 611, nylon 612, nylon 6T, nylon 6/66, nylon 6/12, nylon 6/6T, nylon 6T (terephthalic acid)/6I (isophthalic acid), and nylon MXD6.

The stretched film layer (20) may comprise a transparent deposition layer (not shown) formed on one or both sides thereof. As the stretched film layer (20) comprises the transparent deposition layer, a thermoformable film (100) having transparency can be provided while the gas barrier properties and mechanical strength of the thermoformable film (100) are enhanced. Therefore, when a retort pouch is manufactured using the thermoformable film (100) according to the present disclosure, a retort pouch can be provided in which the long-term storage capability of the contents is significantly enhanced, while the contents can be observed. This transparent deposition layer may be formed on one side of the stretched film layer (20), and the stretched film layer (20) and a second unstretched film layer (30) to be described below may be placed (combined) while the second unstretched film layer (30) and the transparent deposition layer face each other.

According to the present disclosure, the transparent deposition layer may comprise an inorganic substance having transparency, along with excellent gas barrier properties. Specifically, the transparent deposition layer may comprise at least one selected from the group consisting of aluminum oxide (AlOₓ), aluminum oxynitride (AlOₓN_{y}), titanium oxide (TiOₓ), silicon oxide (SiOₓ), zinc oxide (ZnOₓ), tin oxide (SnOₓ), silicon nitride (SiNₓ), aluminum nitride (AlNₓ), silicon oxynitride (SiOₓN_{y}), nickel oxide (NiOₓ), and magnesium oxide (MgOₓ).

The transparent deposition layers may have a thickness of 5 to 50 nm. Specifically, the thickness of the transparent deposition layer may be 7 to 40 nm, 9 to 35 nm, 10 to 30 nm, or 10 to 25 nm. As the thickness of the transparent deposition layer is within the above range, the gas barrier properties of the thermoformable film (100) can be enhanced while the stretched film layer (20) is prevented from being deformed by the transparent deposition layer.

According to the present disclosure, the stretched film layer (20) comprising the transparent deposition layer may have mechanical (physical) properties (e.g., tensile strength, elongation, etc.) controlled to specific ranges. As a result, it is possible to enhance the gas barrier properties and thermoformability (stretchability) of the thermoformable film (100).

Specifically, the stretched film layer (20) may have a tensile strength of 240 to 320 MPa in the longitudinal direction (MD) and the transverse direction (TD), respectively. For example, the tensile strength in the longitudinal direction (MD) of the stretched film layer (20) may be 240 to 310 MPa, 245 to 300 MPa, 250 to 290 MPa, 250 to 280 MPa, 255 to 270 MPa, or 255 to 265 MPa. In addition, the tensile strength in the transverse direction (TD) of the stretched film layer (20) may be 250 to 320 MPa, 260 to 315 MPa, 270 to 315 MPa, 280 to 310 MPa, 290 to 305 MPa, or 295 to 305 MPa. Here, the tensile strength (a) in the longitudinal direction (MD) of the stretched film layer (20) may be smaller than the tensile strength (b) in the transverse direction (TD) thereof (a<b). The tensile strength of the stretched film layer (20) may be measured according to the JIS K 7127 standard (at 23 °C).

The stretched film layer (20) may have an elongation of 80 to 120% in the longitudinal direction (MD) and the transverse direction (TD), respectively. For example, the elongation in the longitudinal direction (MD) of the stretched film layer (20) may be 85 to 120%, 90 to 118%, 95 to 115%, 100 to 113%, or 105 to 112%. In addition, the elongation in the transverse direction (TD) of the stretched film layer (20) may be 80 to 110%, 82 to 105%, 84 to 100%, 86 to 95%, or 88 to 93%. Here, the elongation (c) in the longitudinal direction (MD) of the stretched film layer (20) may be greater than the elongation (d) in the transverse direction (TD) thereof (c>d). The elongation of the stretched film layer (20) may be measured according to the JIS K 7127 standard (at 23 °C).

Meanwhile, the stretched film layer (20) may have a total light transmittance of 85% or more, 86% or more, 87% or more, 88% or more, 89% or more, or 90% or more. The total light transmittance of the stretched film layer (20) may be measured according to the JIS K 7361-1 standard (at 23 °C).

In addition, the stretched film layer (20) may have a haze of 3.5% or less, 3.4% or less, 3.3% or less, 3.2% or less, 3.10% or less, or 3.0% or less. The haze of the stretched film layer (20) may be measured according to the JIS K 7136 standard (at 23 °C).

In addition, the stretched film layer (20) may have a shrinkage rate in the longitudinal direction (MD) of 1.8% or less, 1.7% or less, 1.6% or less, or 1.5% or less (e.g., 1.3 to 1.6%); and a shrinkage rate in the transverse direction (TD) of 2.3% or less, 2.2% or less, 2.1% or less, or 2.0% or less (e.g., 1.9 to 2.1%). The shrinkage rate of the stretched film layer (20) may be measured as the ratio (percentage) of the shrinkage (reduced) length after the stretched film is immersed in water at 95 °C for 5 minutes relative to the initial length thereof.

According to the present disclosure, the stretched film layer (20) may have an oxygen transmission rate (OTR) of 2 cc/m²·day or less (=2 cc/m²·day atm or less) and a water vapor transmission rate (WVTR) of 3 g/m²·day or less. Specifically, the oxygen transmission rate (OTR) of the stretched film layer (20) may be 1.5 cc/m²·day or less, 1.3 cc/m²·day or less, 1.1 cc/m²·day or less, 0.8 cc/m²·day or less, or 0.6 cc/m²·day or less, and 0 cc/m²·day or more, 0.0001 cc/m²·day or more, 0.0002 cc/m²·day or more, 0.0003 cc/m²·day or more, or 0.0004 cc/m²·day or more. In addition, the water vapor transmission rate (WVTR) of the stretched film layer (20) may be 2.5 g/m²·day or less, 2.0 g/m²·day or less, 1.5 g/m²·day or less, 1.1 g/m²·day or less, or 0.8 g/m²·day or less, and 0 g/m²·day or more, 0.00001 g/m²·day or more, 0.00005 g/m²·day or more, 0.0001 g/m²·day or more, 0.0003 g/m²·day or more, or 0.0005 g/m²·day or more. As the oxygen transmission rate (OTR) and water vapor transmission rate (WVTR) of the stretched film layer (20) are each within the above range, the gas barrier properties of the thermoformable film (100) can be enhanced while the thermal resistance and pinhole resistance of the thermoformable film (100) are secured. As a result, it is possible to significantly enhance the long-term storage capability of retort pouches manufactured using the thermoformable film (100). The oxygen transmission rate (OTR) of the stretched film layer (20) may be measured according to the JIS K 7126 standard (at 25 °C and 80% RH). The water vapor transmission rate (WVTR) of the stretched film layer (20) may be measured according to the JIS K 7129 standard (at 40 °C and 90% RH).

According to the present disclosure, the stretched film layer (20) may have a thickness of 5 to 25 μm. Specifically, the thickness of the stretched film layer (20) may be 8 to 23 μm, 10 to 20 μm, 12 to 18 μm, or 14 to 16 μm. As the thickness of the stretched film layer (20) is within the above range, the gas barrier properties and thermoformability of the thermoformable film (100) can be enhanced.

### Second Unstretched Film Layer

The second unstretched film layer (30) contained in the thermoformable film (100) according to the present disclosure serves to secure the thermal resistance, hygroscopic resistance, sealing properties, and thermoformability, and the like of the thermoformable film (100). The second unstretched film layer (30) may be made of a film comprising a polymer resin (third polymer resin), in which case the film may be a film that has not been stretched. The polymer resin (third polymer resin) is not particularly limited, but it may specifically comprise a polypropylene. As the second unstretched film layer (30) comprises the polymer resin, the thermal resistance, sealing properties, and thermoformability of the thermoformable film (100) can be enhanced. For example, the second unstretched film layer (30) may be made of a cast polypropylene (CPP) film.

According to the present disclosure, the second unstretched film layer (30) may have a thickness of 80 to 120 μm. Specifically, the thickness of the second unstretched film layer (30) may be 83 to 118 μm, 85 to 115 μm, 90 to 110 μm, or 95 to 105 μm. As the thickness of the second unstretched film layer (30) is within the above range, the sealing properties and thermoformability of the thermoformable film (100) can be enhanced, while the overall thickness of the thermoformable film (100) can be prevented from becoming thicker than necessary.

Meanwhile, according to the present disclosure, the first unstretched film layer (10), the stretched film layer (20), and the second unstretched film layer (30) may be sequentially laminated. Specifically, as shown in FIG. 1, the thermoformable film (100) according to the present disclosure may have a structure in which a first unstretched film layer (10); a stretched film layer (a stretched polyamide base layer and a transparent deposition layer) (20); and a second unstretched film layer (30) are laminated in this sequence. By virtue of this layered structure, it can have excellent thermoformability. Here, in order to increase the bonding strength between the respective layers, an adhesive layer may be interposed between the first unstretched film layer (10) and the stretched film layer (20) and/or between the stretched film layer (20) and the second unstretched film layer (30).

In the thermoformable film (100) according to the present disclosure, the sum (T₁+T₂) of the thickness (T₁) of the first unstretched film layer (10) and the thickness (T₂) of the stretched film layer (20) may be smaller than the thickness (T₃) of the second unstretched film layer (30) (T₁+T₂<T₃). With such a thickness difference, the thickness of the thermoformable film (100) is prevented from becoming excessively thin during the process of thermoforming (stretching) the thermoformable film (100) to fit the mold shape, so that the gas barrier properties of the thermoformable film (100) can be secured even after thermoforming is carried out.

According to the present disclosure, the thickness ratio (T₁:T₂:T₃) between the first unstretched film layer (10), the stretched film layer (20), and the second unstretched film layer (30) is not particularly limited, but it may be 1:0.1 to 0.5:1.5 to 2.5, 1:0.2 to 0.4:1.7 to 2.3, or 1:0.2 to 0.3:1.8 to 2.1.

As the thermoformable film (100) according to the present disclosure comprises the stretched film layer (20) having high gas barrier properties and thermoformability (stretchability); and the first unstretched film layer (10) and the second unstretched film layer (30) having excellent thermoformability (stretchability), the gas barrier properties can be excellent even after the thermoforming process, or after the thermoforming process and the heat sterilization process. That is, the thermoformable film (100) according to the present disclosure can have relatively low oxygen transmission rates (OTR) and water vapor transmission rates (WVTR) even after it has been subjected to a thermoforming process or both a thermoforming process and a heat sterilization process.

Specifically, according to the present disclosure, the thermoformable film (100) may have an oxygen transmission rate (OTR) of 20 cc/m²·day or less (=20 cc/m²·day atm or less) when measured after it is thermoformed at 120 to 155 °C. More specifically, the oxygen transmission rate (OTR) of the thermoformable film (100), after it is thermoformed, may be 15 cc/m²·day or less, 13 cc/m²·day or less, 10 cc/m²·day or less, 8 cc/m²·day or less, 5 cc/m²·day or less, or 1 cc/m²·day or less, and 0 cc/m²·day or more, 0.0001 cc/m²·day or more, 0.001 cc/m²·day or more, 0.01 cc/m²·day or more, 0.05 cc/m²·day or more, or 0.1 cc/m²·day or more. Here, the time for thermoforming the thermoformable film (100) at 120 to 155 °C (specifically, 125 to 155 °C, 130 to 155 °C, or 135 to 155 °C) is not particularly limited, but it may be 3 to 15 seconds, 5 to 13 seconds, or 7 to 10 seconds. For example, the thermoforming of the thermoformable film (100) may be carried out by a procedure of thermal treatment at 120 to 155 °C for 3 seconds and foaming for 5 seconds while the temperature is maintained at 120 to 155 °C.

In addition, according to the present disclosure, when the thermoformable film (100) is thermoformed at 120 to 155 °C and heated at 110 to 130 °C for 20 to 30 minutes (after being subjected to both the thermoforming and heat sterilization processes), the measured oxygen transmission rate (OTR) may be 15 cc/m²·day or less (=15 cc/m²·day atm or less). More specifically, the oxygen transmission rate (OTR) of the thermoformable film (100), after it is subjected to the thermoforming and thermal treatment, may be 12 cc/m²·day or less, 9 cc/m²·day or less, 7 cc/m²·day or less, 5 cc/m²·day or less, or 3.5 cc/m²·day or less, and 0 cc/m²·day or more, 0.0001 cc/m²·day or more, 0.0002 cc/m²·day or more, 0.0003 cc/m²·day or more, 0.0004 cc/m²·day or more, or 0.0005 cc/m²·day or more. Here, heating of the thermoformable film (100) that has been thermoformed may be carried out by, for example, storing it in steam at 110 to 130 °C or in hot water at 110 to 130 °C under atmospheric pressure, or a higher pressure, for 20 to 30 minutes.

### Process for Preparing a Thermoformable Film

The present disclosure provides a process for preparing a thermoformable film that can efficiently prepare the thermoformable film described above. Specifically, the process for preparing a thermoformable film according to the present disclosure comprises preparing a first unstretched film, a stretched film, and a second unstretched film, respectively; and sequentially laminating and combining the first unstretched film, the stretched film, and the second unstretched film (see FIG. 2).

The step of preparing each of the films may comprise preparing a first unstretched film for forming the first unstretched film layer described above, a stretched film for forming the stretched film layer described above, and a second unstretched film for forming the second unstretched film layer described above, respectively.

The first unstretched film may be an unstretched film comprising the polymer resin (first polymer resin) described above.

The stretched film may be a film obtained by uniaxially or biaxially stretching an unstretched film (second unstretched film) comprising the polymer resin (second polymer resin) described above and then subjecting it to a deposition process. Specifically, the stretched film may be obtained by stretching the unstretched film in at least one direction of the longitudinal direction (MD) and the transverse direction (TD); and subjecting it to a deposition process. The deposition process may be carried out by depositing an inorganic substance that is transparent and has excellent gas barrier properties onto a film that has been subjected to the stretching process. Here, the inorganic substance may comprise at least one selected from the group consisting of aluminum oxide (AlOₓ), aluminum oxynitride (AlOₓN_{y}), titanium oxide (TiOₓ), silicon oxide (SiOₓ), zinc oxide (ZnOₓ), tin oxide (SnOₓ), silicon nitride (SiNₓ), aluminum nitride (AlNₓ), silicon oxynitride (SiOₓN_{y}), nickel oxide (NiOₓ), and magnesium oxide (MgOₓ). In addition, the deposition process may be a commonly known deposition process (e.g., sputter deposition; ion plating; or vacuum deposition using high-frequency heating, electron beam heating, etc.).

The second unstretched film may be an unstretched film comprising the polymer resin (third polymer resin) described above. Specifically, the unstretched film may be a cast polypropylene film (CPP).

The step of combining the respective films may comprise sequentially laminating the first unstretched film, the stretched film, and the second unstretched film; and combining them using a commonly known lamination method. In addition, the process may comprise applying an adhesive to one side of at least one of the first unstretched film, the stretched film, and the second unstretched film before laminating the respective films; and sequentially laminating and combining the films. The adhesive may be an adhesive commonly used in the manufacture of films.

### Retort Pouch

The present disclosure provides a retort pouch that comprises the thermoformable film described above. Specifically, the retort pouch according to the present disclosure is manufactured by laminating a top film and a bottom film and then performing a conventional sealing process, wherein at least one of the top film and the bottom film may be the thermoformable film described above. Since the retort pouch according to the present disclosure comprises the thermoformable film described above, it can be easily thermoformed into a desired shape, and it can have excellent gas barrier properties even after thermoforming. In particular, the retort pouch according to the present disclosure has excellent gas barrier properties even when heat sterilization is carried out under harsher conditions than boiling water sterilization, whereby it is possible to achieve an extension of the shelf life of the contents (e.g., processed meat products).

The retort pouch according to the present disclosure may have various types such as a box pouch, a three-way pouch, a T-way pouch, an M-way pouch, and the like.

Hereinafter, the present disclosure will be described in detail with reference to examples. However, the scope of the present disclosure is not limited to the following examples.

### MODE FOR THE INVENTION

### <Preparation of a Thermoformable Film>

### Example 1

A polyamide film having a thickness of 50 μm was prepared as a first unstretched film, a polyamide film deposited with silicon dioxide and having a thickness of 15 μm was prepared as a stretched film, and a polypropylene film (CPP film) having a thickness of 100 μm was prepared as a second unstretched film. In such an event, the properties of each film are summarized in Table 1 below.

Next, the first unstretched film layer (polyamide film layer), the stretched film layer (silicon dioxide-deposited polyamide film layer), and the second unstretched film layer (polypropylene film layer) were laminated in this sequence using a lamination method to manufacture a thermoformable film.

TABLE 1

| | | First unstretched film | Stretched film |
|---|---|---|---|
| Oxygen transmission rate | | 20 or less | 0.6 or less |
| (cc/m² · day) | | | |
| Water vapor transmission rate | | 162 or less | 0.8 or less |
| (g/m² · day) | | | |
| Tensile strength | MD | 140 | 260 |
| (MPa) | TD | 130 | 300 |
| Elongation | MD | 410 | 110 |
| (%) | TD | 430 | 90 |

| | | |
|---|---|---|
| Haze (%) | 3.5 or less | 3.0 or less |

### Comparative Example 1

A multilayer coextruded film (Xiangfu, 620C) manufactured using an unstretched film was used.

### <Preparation of a Retort Pouch>

### Preparation Example 1

The thermoformable film of Example 1 was used as a top film and a bottom film, conventionally used in the manufacture of retort, which were laminated and sealed to manufacture a three-way type retort pouch.

### Comparative Preparation Example 1

The coextruded film of Comparative Example 1 was used as a top film and a bottom film, conventionally used in the manufacture of retort, which were laminated and sealed to manufacture a three-way type retort pouch.

### Test Example 1: Evaluation of Thermoformability

Ham products were placed in the retort pouches manufactured in Preparation Example 1 and Comparative Preparation Example 1, respectively, and final sealing was performed to manufacture processed products. Thereafter, the presence of a rounding phenomenon (a phenomenon in which a right angle is not formed) at the four corners of the processed products was visually observed. The results are shown in Table 2 below.
◯: No rounding at the four corners
Δ: Rounding at 1 to 2 of the four corners
x: Rounding at all the four corners

### Test Example 2: Measurement of Oxygen Transmission Rates

The thermoformable films manufactured in Example 1 and Comparative Example 1 were each placed in a mold having a depth of 10 mm and thermoformed at 140 to 155 °C for 8 seconds. Next, the thermoformed film was heat sterilized at 118 °C for 25 minutes. Thereafter, the oxygen transmission rates of the thermoformed and heat-sterilized film were measured using a Mocon Oxtran device according to ASTM D3985 (at 23 °C and 50% RH). The results are shown in Table 2 below.

TABLE 2

| | Ex. 1 | C. Ex. 1 |
|---|---|---|
| | (Prep. Ex. 1) | (C. Prep. Ex. 1) |
| Thermoformability | Δ | ○ |
| Oxygen transmission rate | 0.310 | 1.366 |
| before thermoforming (cc/m² · day) | | |
| Oxygen transmission rate | 3.362 | 18.924 |
| after thermoforming and heat | | |
| sterilization (cc/m² · day) | | |

Referring to FIG. 2 above, the thermoformable film according to the present disclosure had excellent gas barrier properties with significantly low oxygen transmission rates even after thermoforming and heat sterilization while thermoformability was secured.

### EXPLANATION OF REFERENCE NUMERALS

100: thermoformable film
10: first unstretched film layer
20: stretched film layer
30: second unstretched film layer

1. A thermoformable film, which comprises a first unstretched film layer; a stretched film layer comprising a transparent deposition layer formed on one or both sides thereof;
and a second unstretched film layer.

2. The thermoformable film of claim 1, which has an oxygen transmission rate (OTR) of 20 cc/m2·day or less when measured after it is thermoformed at 120 to 155 °C.

3. The thermoformable film of claim 2, which has an oxygen transmission rate (OTR) of 15 cc/m2·day or less when measured after the thermoformed film is heated at 110 to 130 °C for 20 to 30 minutes.

4. The thermoformable film of claim 1, wherein the first unstretched film layer has a tensile strength in the longitudinal direction (MD) and the transverse direction (TD) of 110 to 160 MPa, respectively, and an elongation in the longitudinal direction (MD) and the transverse direction (TD) of 400 to 440%, respectively.

5. The thermoformable film of claim 1, wherein the stretched film layer has a tensile strength in the longitudinal direction (MD) and the transverse direction (TD) of 240 to 320 MPa, respectively, and an elongation in the longitudinal direction (MD) and the transverse direction (TD) of 80 to 120%, respectively.

6. The thermoformable film of claim 1, wherein the first unstretched film layer has an oxygen transmission rate (OTR) of 30 cc/m2·day or less and a water vapor transmission rate (WVTR) of 250 g/m2·day or less.

7. The thermoformable film of claim 1, wherein the stretched film layer has an oxygen transmission rate (OTR) of 2 cc/m2·day or less and a water vapor transmission rate (WVTR) of 3 g/m2·day or less.

8. The thermoformable film of claim 1, wherein the first unstretched film layer and the stretched film layer each comprise a polyamide, and the second unstretched film layer comprises a polypropylene.

9. The thermoformable film of claim 1, wherein the sum of the thickness of the first unstretched film layer and the thickness of the stretched film layer is smaller than the thickness of the second unstretched film layer.

10. The thermoformable film of claim 1, wherein the thickness of the first unstretched film layer is 40 to 60 μm, the thickness of the stretched film layer is 5 to 25 μm, and the thickness of the second unstretched film layer is 80 to 120 μm.

11. The thermoformable film of claim 1, wherein the first unstretched film layer, the stretched film layer, and the second unstretched film layer are sequentially laminated.

12. The thermoformable film of claim 1, wherein the transparent deposition layer comprises at least one selected from the group consisting of aluminum oxide, aluminum oxynitride, titanium oxide, silicon oxide, zinc oxide, tin oxide, silicon nitride, aluminum nitride, silicon oxynitride, nickel oxide, and magnesium oxide.

13. A process for preparing a thermoformable film, which comprises preparing a first unstretched film, a stretched film, and a second unstretched film, respectively; and sequentially laminating and combining the first unstretched film, the stretched film, and the second unstretched film.

14. A retort pouch, which comprises the thermoformable film claim 1.
